(19) United States
(12) Patent Application Publication
(10) Pub. No.: US 2022/0076588 A1
(43) Pub. Date: Mar. 10, 2022

(54) APPARATUS AND METHOD FOR PROVIDING FOREIGN LANGUAGE EDUCATION USING FOREIGN LANGUAGE SENTENCE EVALUATION OF FOREIGN LANGUAGE LEARNER

(71) Applicant: ELECTRONICS AND TELECOMMUNICATIONS RESEARCH INSTITUTE, Daejeon (KR)

(72) Inventor: Oh Woog KWON, Daejeon (KR)

(21) Appl. No.: 17/466,167

(22) Filed: Sep. 3, 2021

(30) Foreign Application Priority Data
Sep. 8, 2020 (KR) 10-2020-0114970

(51) Int. Cl. G09B 19/06; G09B 7/02

(52) U.S. Cl. CPC G09B 19/06; G09B 7/02

(57) ABSTRACT

Provided is a method for providing foreign language education based on evaluation of a foreign language sentence of a foreign language learner, the method including: receiving at least one foreign language sentence generated from a foreign language learner; inputting the foreign language sentence into a first evaluation model corresponding to a first evaluation item among a plurality of evaluation items to calculate a first evaluation result value; comparing the calculated first evaluation result value with a predetermined result value; and when a result of the comparison is that the first evaluation result value is less than the predetermined result value, providing education information corresponding to the first evaluation item to the foreign language learner.

### CROSS-REFERENCE TO RELATED APPLICATION

This application claims priority to and the benefit of Korean Patent Application No. 10-2020-0114970, filed on Sep. 8, 2020, the disclosure of which is incorporated herein by reference in its entirety.

### BACKGROUND

### 1. Field of the Invention

The present invention relates to an apparatus and method for providing foreign language education based on evaluation of a foreign language sentence of a foreign language learner.

### 2. Description of Related Art

Learners (hereinafter referred to as foreign language learners) who are learning foreign languages may learn a foreign language faster when learning the foreign language by identifying whether communication succeeds with the foreign language in real situations. For this reason, various types of foreign language education software have recently been released that allow foreign language learners to generate (speak or write) foreign language sentences as if they are in a real situation.

However, even in this case, it is impossible to evaluate whether a foreign language sentence generated by a foreign language learner is grammatically correct in linguistics, appropriately delivers content, or is expressive of actual use. Such an evaluation and corresponding correction information may only be provided by a foreign language teacher in charge.

In foreign language education software, in the case of reading along, learning sentence pattern writing, and the like having only a single correct answer sentence, the speaking and writing of foreign language learners may be easily evaluated. However, in the case of writing or speaking a foreign language in an arbitrary situation, the writing or speaking may not be easily evaluated due to there being various correct answers.

In addition, it is very difficult and almost impossible to collect all of the various correct answer sentences, and even when all the correct answer sentences are collected, simple literal comparison of foreign language sentences by foreign language learners with the correct answer sentences does not provide the same evaluation result as that of an actual foreign language teacher.

### SUMMARY OF THE INVENTION

The present invention is directed to providing an apparatus and method for providing foreign language education based on evaluation of a foreign language sentence of a foreign language learner that are capable of, with respect to a foreign language sentence spoken or written by a foreign language learner, evaluating content delivery competency, grammatical correctness, and expressive fluency through an evaluation model trained using linguistic knowledge of foreign language teachers, and providing the foreign language learner with education information according to a result of the evaluation.

The technical objectives of the present invention are not limited to the above, and other objectives may become apparent to those of ordinary skill in the art based on the following description.

According to the first aspect of the present invention, there is provided a method for providing foreign language education based on evaluation of a foreign language sentence of a foreign language learner, the method including receiving at least one foreign language sentence generated from a foreign language learner, inputting the foreign language sentence into a first evaluation model corresponding to a first evaluation item among a plurality of evaluation items to calculate a first evaluation result value, comparing the calculated first evaluation result value with a predetermined result value, and when a result of the comparison is that the first evaluation result value is less than the predetermined result value, providing education information corresponding to the first evaluation item to the foreign language learner. In this case, evaluation models corresponding to the plurality of evaluation items are trained on the basis of training data prepared in advance for each of the plurality of evaluation items, and the training data prepared in advance includes a plurality of foreign language sentences previously generated from the foreign language learner and a first evaluation result value of the previously generated plurality of foreign language sentences by a foreign language teacher.

According to the second aspect of the present invention, there is provided an apparatus for providing foreign language education based on evaluation of a foreign language sentence of a foreign language learner, the apparatus including a communication module configured to receive at least one foreign language sentence generated from a foreign language learner, a memory in which a program for providing education information to the foreign language learner on the basis of a result of evaluating the foreign language sentence is stored, and a processor configured to execute the program stored in the memory. In this case, the processor executes the program to input the foreign language sentence into evaluation models corresponding to a plurality of evaluation items to calculate evaluation result values, and as a result of comparing each of the calculated evaluation result values with a predetermined result value, provide education information corresponding to the evaluation item associated with the evaluation result value which is less than the predetermined result value to the foreign language learner, the evaluation models corresponding to the plurality of evaluation items are trained on the basis of training data prepared in advance for each of the plurality of evaluation items, and the training data prepared in advance includes a plurality of foreign language sentences previously generated from the foreign language learner and an evaluation result value of the previously generated plurality of foreign language sentences by a foreign language teacher.

According to the third aspect of the present invention, there is provided an apparatus for providing foreign language education based on evaluation of a foreign language sentence of a foreign language learner, the apparatus including a communication module configured to receive at least one foreign language sentence generated from a foreign language learner, a memory in which a program is stored, wherein the program is for evaluating evaluation items of a content delivery competency, grammatical correctness, and an expressive fluency with respect to the foreign language sentence, and providing the foreign language learner with education information corresponding to each of the evaluation items; and a processor configured to execute the program stored in the memory. In this case, the processor executes the program to input the foreign language sentence into evaluation models corresponding to the evaluation items of the content delivery competency, the grammatical correctness, and the expressive fluency to calculate evaluation result values, and as a result of comparing each of the calculated evaluation result values with a predetermined result value, provide education information corresponding to the evaluation item associated with the evaluation result value which is less than the predetermined result value to the foreign language learner, the evaluation models corresponding to the plurality of evaluation items are trained on the basis of training data prepared in advance for each of the plurality of evaluation items, and the training data prepared in advance includes a plurality of foreign language sentences previously generated from the foreign language learner and an evaluation result value of the previously generated plurality of foreign language sentences by a foreign language teacher.

In addition, other methods and other systems for implementing the present invention, and a computer readable recoding medium that records a computer program for executing the method may be further provided.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A-1C are diagrams for describing a method of providing foreign language education according to an embodiment of the present invention;

FIG. 2 is a diagram illustrating an example of evaluating a plurality of evaluation items;

FIG. 3 is a diagram for describing a first evaluation model;

FIG. 4 is a diagram for describing a second evaluation model;

FIG. 5 is a diagram for describing a third evaluation model; and

FIG. 6 is a diagram for describing an apparatus for providing foreign language education according to an embodiment of the present invention.

### DETAILED DESCRIPTION OF EXEMPLARY EMBODIMENTS

Hereinafter, the advantages and features of the present invention and ways of achieving them will become readily apparent with reference to descriptions of the following detailed embodiments in conjunction with the accompanying drawings. However, the present invention is not limited to such embodiments and may be embodied in various forms. The embodiments to be described below are provided only to assist those of ordinary skill in the art in fully understanding the scope of the present invention, and the scope of the present invention is defined only by the appended claims.

Terms used herein are used to aid in the explanation and understanding of the embodiments and are not intended to limit the scope and spirit of the present invention. It should be understood that the singular forms “a” and “an” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof. In connection with assigning reference numerals to elements in the drawings, the same reference numerals are used to designate the same elements through the whole specification, and the term “and/or” includes any one or combinations of the associated listed items. It should be understood that, although the terms “first,” “second,” etc. may be used herein to describe various elements, these elements are not limited by these terms. These terms are only used to distinguish one element from another. For example, a first element could be termed a second element without departing from the scope of the present invention.

Unless otherwise defined, all terms (including technical and scientific terms) used herein have the same meaning as commonly understood by one of ordinary skill in the art to which this invention belongs. It should be further understood that terms, such as those defined in commonly used dictionaries, should not be interpreted in an idealized or overly formal sense unless expressly so defined herein.

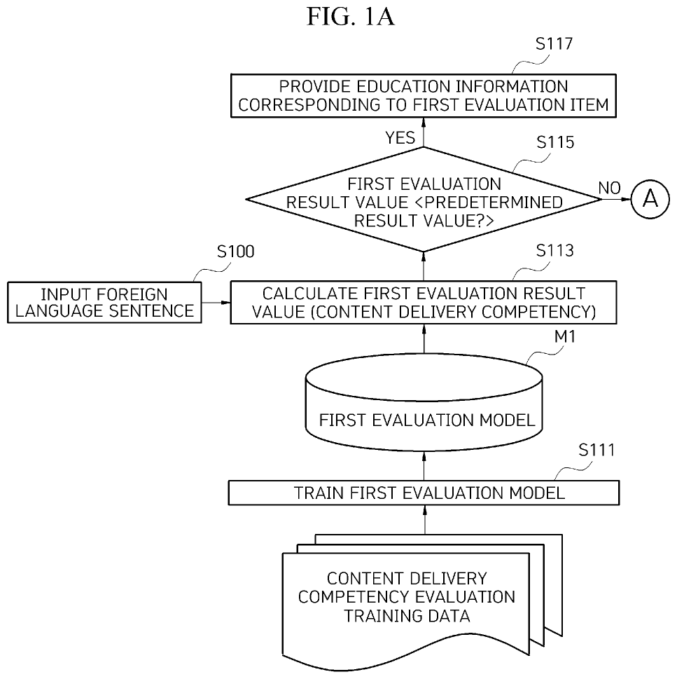

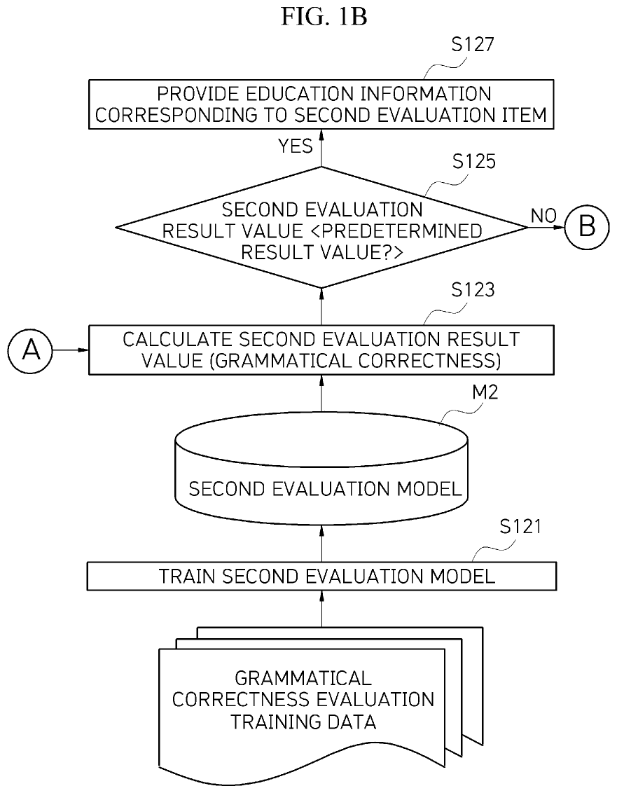

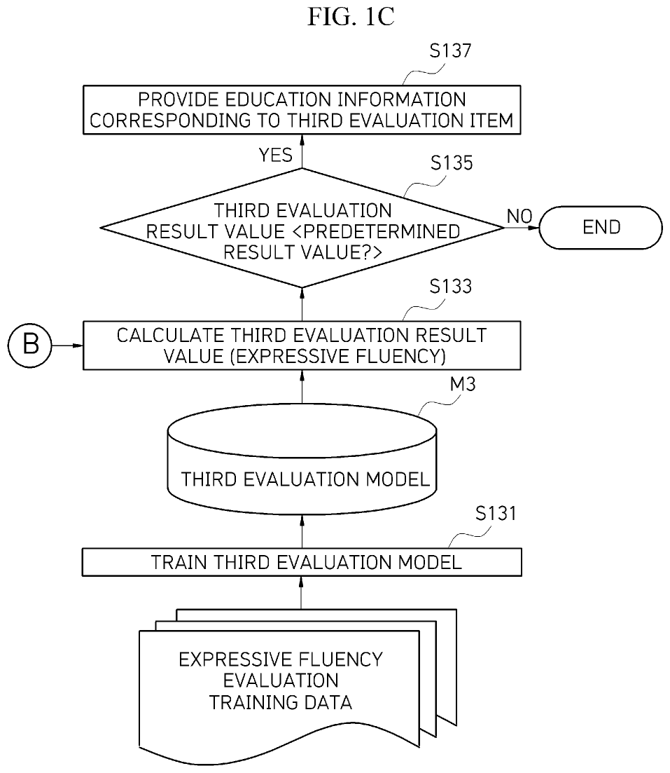

Hereinafter, a method of providing foreign language education based on evaluation of a foreign language sentence by a foreign language learner according to an embodiment of the present invention (hereinafter referred to a method of providing foreign language education) will be described with reference to FIGS. 1 to 5.

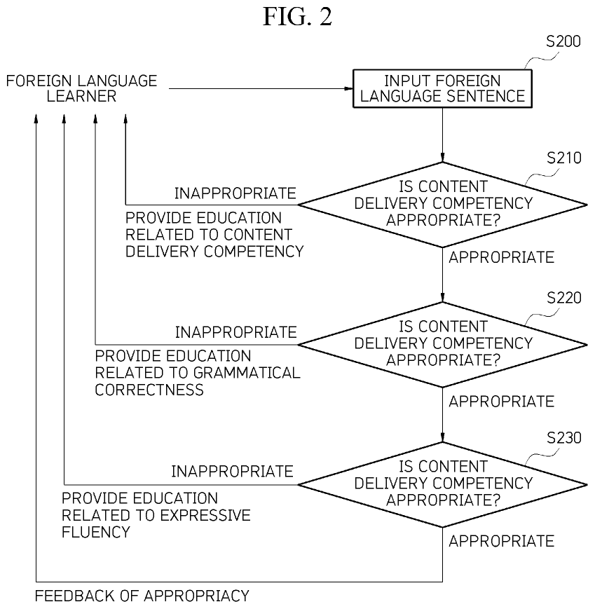

FIG. 1 is a diagram for describing a method of providing foreign language education according to an embodiment of the present invention. FIG. 2 is a diagram illustrating an example of evaluating a plurality of evaluation items.

Meanwhile, operations shown in FIG. 1 may be understood as being performed by, but not limited to, a server operated by an apparatus 100 for providing foreign language education.

In addition, a foreign language learner and a foreign language teacher, although they are simply expressed in the description of the present invention, may transmit and receive data to and from the server through a computer device or a telecommunication device, such as a smartphone, a tablet personal computer (PC), a personal digital assistant (PDA), a laptop computer, a desktop computer, or a server.

The method of providing foreign language education according to the embodiment of the present invention evaluates a content delivery competency, grammatical correctness, and an expressive fluency from a foreign language sentence input from a foreign language learner and provides education information corresponding to each evaluation item on the basis of the evaluation result.

In this case, the content delivery competency is for evaluating whether a sentence written or spoken by a foreign language learner sufficiently contains content which is to be delivered. In addition, the corresponding education information, when the sentence written or spoken by the foreign language learner is evaluated as insufficiently containing the content to be delivered, is for providing the foreign language learner with content information related to the evaluation.

In addition, the grammatical correctness is for evaluating whether a sentence written or spoken by a foreign language learner is grammatically correct. In addition, the corresponding education information, when the sentence written or spoken by the foreign language learner has a grammatical error, is for providing the foreign language learner with content information for correcting the error.

Finally, the expressive fluency is for evaluating whether a sentence written or spoken by a foreign language learner is an expression widely used in a language area that uses a foreign language. In addition, the corresponding education information, when the sentence written or spoken by the foreign language learner is determined to be not fluent, is for providing the foreign language learner with content information associated with fluent expressions having the same meaning.

Such an evaluation of the content delivery competency, the grammatical correctness, and the expressive fluency may be individually performed or may be evaluated sequentially as shown in FIG. 2. That is, in an embodiment of the present invention, as shown in FIG. 2, the foreign language learner may be provided with evaluation and education information for the content delivery competency, the grammatical correctness, and the expressive fluency by stages so that the foreign language learner may not receive complex education information collectively but may receive appropriate education information according to a specific level of the generated foreign language sentence.

As an embodiment, referring to FIG. 2, first, the server, upon receiving a foreign language sentence from a foreign language learner (S200), evaluates the content delivery competency of the input foreign language sentence, and when the content delivery competency is evaluated as being appropriate, evaluates the grammatical correctness, and when the content delivery competency is evaluated as being inappropriate, provides the foreign language learner with education information related to the content to be expressed (S210).

Then, the server evaluates the grammatical correctness of the foreign language sentence of the foreign language learner, and when the grammatical correctness is evaluated as being appropriate, evaluates the expressive fluency, and when the grammatical correctness is evaluated as being inappropriate, provides the foreign language learner with education information for identifying the incorrect grammar or suggesting content to be corrected (S220).

Then, the server evaluates the expressive fluency of the foreign language sentence of the foreign language learner, and when the expressive fluency is evaluated as being appropriate, provides the foreign language learner with the evaluation result as having appropriately written or spoken the foreign language sentence according to all evaluation items, and when the expressive fluency is evaluated as being inappropriate, provides the foreign language learner with education information capable of ensuring more fluent expression (S230).

Specifically, referring to FIG. 1, the server receives at least one foreign language sentence generated from a foreign language learner (S100).

In one embodiment of the present invention, the foreign language is not limited to a specific language, such as English, but may apply to any language, such as Japanese, Chinese, French, German, or Korean. In addition, the embodiment of the present invention does not exclude Korean, so it should be understood that when foreigners are targeted, Korean may also be used as a foreign language.

For reference, in the present invention, a person who is learning a foreign language is expressed as a foreign language learner, and a foreign language expert who has the ability to educate foreign language learners due to majoring in a foreign language is expressed as a foreign language teacher to be distinguished from the foreign language leaner. Here, a foreign language teacher may be eligible when he/she satisfies having a license or a predetermined career.

Next, the server inputs the foreign language sentence into a first evaluation model M1 corresponding to a first evaluation item among a plurality of evaluation items to calculate an evaluation result value (S113). In this process, it is evaluated whether the content convey competency for the foreign language sentence by the foreign language learner is appropriate on the basis of the first evaluation model M1, which is pre-trained.

To this end, the server may perform training on the first evaluation model M1 on the basis of training data prepared in advance (S111).

Here, the training data prepared in advance may be content delivery competency evaluation training data. The content delivery competency evaluation training data is data, with respect to foreign language sentences generated by foreign language learners having various skills and experiences with respect to a content and situation defined in a preset context condition that is recognized in native languages of the foreign language learners, that is obtained by evaluating whether the foreign language sentences appropriately deliver content and scoring the evaluation by the foreign language teachers.

Accordingly, the content delivery competency evaluation training data includes foreign language sentences generated by a plurality of foreign language learners based on a preset situation condition, a correct answer sentence corresponding to the foreign language sentence, and an average first evaluation result value evaluated by a plurality of foreign language teachers on the basis of the correct answer sentence.

For example, in general, the foreign language teachers for evaluation may be preferably set to three or four people, and the evaluation score may be set to zero to four points. The evaluation criteria may vary depending on an education object or methodology, and a first evaluation result value of four points is assigned when the content to be delivered is completely delivered, and a first evaluation result value of zero points is assigned when the content is not delivered at all.

In this case, the average first evaluation result value by the foreign language teachers may be converted to a value between zero and one when the first evaluation model M1 is a regression model, and the average first evaluation result value may be determined as a score between zero and four that is the most similar to the average score when the first evaluation model M1 is a classification model.

The server generates the first evaluation model M1 to be similar to the result of the foreign language sentences actually evaluated by the foreign language teachers in terms of the content delivery competency on the basis of the content delivery competency evaluation training data. For example, the server may train the first evaluation model M1 to be similar to the evaluation result by the foreign language teachers to a preset degree of reliability required for learning.

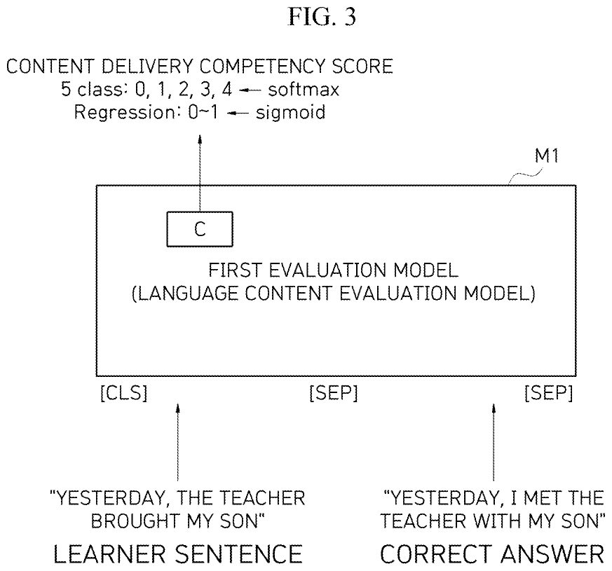

FIG. 3 is a diagram for describing the first evaluation model M1.

In one embodiment, with respect to the first evaluation model M1 based on a neural network that is pre-trained on the basis of a large-capacity language corpus collected for a predetermined period, the server may set the foreign language sentence and the correct answer sentence in the data prepared in advance as input data and set the average first evaluation result value as output data to train the first evaluation model M1.

Here, the first evaluation model M1 may be a neural network-based language model, such as a Bidirectional Encoder Representations from Transformers (BERT), pre-trained using a latest large-capacity language corpus.

The server may construct the first evaluation model M1 by setting the foreign language sentence by the foreign language learner and the correct answer sentence in the content delivery competency evaluation training data as an input of the first evaluation model M1, and training the model by fine-tuning learning such that the result is determined as the average first evaluation result value by the foreign language teachers.

When the construction of the first evaluation model M1 is completed as such, the server inputs a foreign language sentence input by a foreign language learner and a correct answer sentence, which correspond to a preset situation condition, into the first evaluation model M1. In addition, the server calculates a first evaluation result value of evaluating the content delivery competency of the foreign language sentence compared to the correct answer sentence on the basis of the first evaluation model M1.

In one embodiment, the server may classify the content delivery competency of the foreign language sentence input by the foreign language learner into a score between zero and four points when using a classification model and output an evaluation result value between zero and one when using a regression model. In this case, as the result becomes closer to four points in the classification model, and the result becomes closer to one in the regression model, the content delivery competency of the foreign language sentence generated by the foreign language learner is considered to be high.

Referring to FIG. 1 again, the server compares the calculated first evaluation result value with a predetermined result value (S115), and when a result of the comparison is determined that the first evaluation result is less than the predetermined result value, provides the foreign language learner with education information corresponding to the first evaluation item (S117).

For example, when the first evaluation result value by the classification model is less than three points, or when the first evaluation result value by the regression model is less than 0.7, the server may determine the first evaluation result value to be inappropriate and provide the foreign language learner with education information.

In one embodiment, the server may provide, as education information related to the content delivery competency, the first evaluation result value converted into a predetermined score (for example, 100 points) or the degree of inappropriacy converted into a predetermined grade to the foreign language learner. In addition, the server may provide a correct answer sentence without change or may extract a keyword in the correct answer sentence that is not included in the foreign language sentence input by the foreign language learner and provide the extracted keyword as education information.

In this case, the keyword may be an important keyword extracted according to a predetermined condition among all keywords, and the important keyword may be extracted based on the above-described degree of reliability.

The foreign language learner who is provided with the education information related to content delivery competency may identify which part of the foreign language sentence spoken or written by him or herself is wrong or missing such as to cause insufficiency of content delivery competency.

On the other hand, the server may compare the calculated first evaluation result value with the predetermined result value, and when the first evaluation result value is greater than or equal to the predetermined result value, input the foreign language sentence into a second evaluation model M2 corresponding to the second evaluation item following the first evaluation item to calculate a second evaluation result value (S123). In this process, the server evaluates the grammatical correctness of the foreign language sentence of the foreign language learner on the basis of the second evaluation model M2 that is pre-trained.

The server may perform training on the second evaluation model M2 on the basis of training data prepared in advance (S121).

In this case, the training data prepared in advance may be grammatical correctness evaluation training data. The grammatical correctness evaluation training data is data, with respect to foreign language sentences generated by foreign language learners having various skills and experiences, that is obtained by evaluating whether the foreign language sentences of the foreign language learners are correct only in a grammatic aspect and scoring the evaluation by the foreign language teachers.

Accordingly, the grammatical correctness evaluation training data includes foreign language sentences generated by a plurality of foreign language learners and an average second evaluation result value obtained by evaluating the grammatical correctness of the foreign language sentences in scores by the foreign language teachers.

In general, the foreign language teachers for evaluation may be preferably set to three or four people, and the evaluation score may be set to zero to four points. The evaluation criteria may vary depending on an education object or methodology, and a second evaluation result value of four points is assigned when the grammatical correctness is perfect, and a second evaluation result value of zero points is assigned when the grammatical correctness is the lowest.

In this case, the average second evaluation result value by the foreign language teachers may be converted to a value between zero and one when the second evaluation model M2 is a regression model, and the average second evaluation result value may be determined as a score between zero and four that is the most similar to the average score when the second evaluation model M2 is a classification model.

The server generates the second evaluation model M2 to be similar to the result of the foreign language sentences of the foreign language students actually evaluated by the foreign language teachers on the basis of the grammatical correctness evaluation training data. For example, the server may train the second evaluation model M2 to be similar to the evaluation result by the foreign language teachers to a preset degree of reliability required for learning. In this case, the preset degree of reliability may be determined, for example, according to a proportion that matches detailed evaluation item objects of grammatical correctness evaluated by foreign language teachers in practice, or according to a predetermined error ratio of result values of grammatical correctness evaluated for the same foreign language sentence by foreign language teachers.

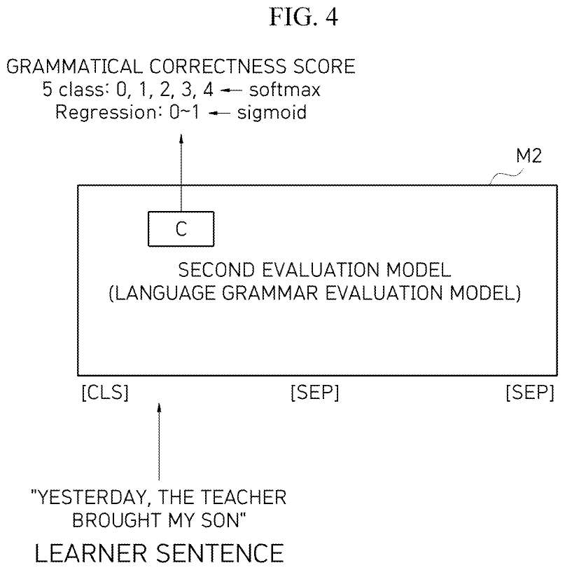

FIG. 4 is a diagram for describing the second evaluation model M2.

In one embodiment, with respect to the second evaluation model M2 based on a neural network that is pre-trained based on a large-capacity language corpus collected for a predetermined period, the server may set the foreign language sentence in the grammatical correctness evaluation training data as input data and set the average second evaluation result value as output data to train the second evaluation model M2.

Here, the second evaluation model M2 may be a neural network-based language model, such as BERT, pre-trained using a latest large-capacity language corpus, similar to the first evaluation model M1.

The server may construct the second evaluation model M2 by setting the foreign language sentence of the foreign language learner in the grammatical correctness evaluation training data as an input of the second evaluation model M2 and training the model by fine-tuning learning such that the result is determined as the average second evaluation result value by the foreign language teachers.

When the construction of the second evaluation model M2 is completed as such, the server inputs a foreign language sentence input by a foreign language learner into the second evaluation model M2. In addition, the server calculates a second evaluation result value of evaluating the grammatical correctness of the foreign language sentence on the basis of the second evaluation model M2.

In one embodiment, the server may classify the grammatical correctness of the foreign language sentence input by the foreign language learner into a score between zero and four points when using a classification model and output an evaluation result value between zero and one when using a regression model. In this case, as the result becomes closer to four points in the classification model and the result becomes closer to one in the regression model, the grammatical correctness of the foreign language sentence generated by the foreign language learner is considered to be high.

Referring to FIG. 1 again, the server compares the calculated second evaluation result value with a predetermined result value (S125), and when a result of the comparison is determined that the second evaluation result is less than the predetermined result value, provides the foreign language learner with education information corresponding to the second evaluation item (S127).

For example, when the second evaluation result value by the classification model is less than three points, or when the second evaluation result value by the regression model is less than 0.7, the server may determine the grammatical correctness to be inappropriate and thus provide the foreign language learner with education information corresponding to grammatical correctness.

In one embodiment, the server may provide, as education information related to the grammatical correctness, the second evaluation result value converted into a predetermined score (for example, 100 points) or the degree of inappropriacy converted into a predetermined grade or converted into a picture representation to the foreign language learner.

In addition, the server may provide, as the education information, a correct answer sentence input by another foreign language learner and evaluated as a correct answer, or a correct answer sentence among pre-prepared correct answer sentences determined to have a highest similarity. In this case, determination of whether a correct answer sentence has a highest similarity may depend on a criterion of determining the above-described preset degree of reliability. For example, whether the correct answer sentence has a highest similarity may be determined according to a proportion that matches detailed evaluation item objects of grammatical correctness evaluated by foreign language teachers in practice, or according to a predetermined error ratio of result values of grammatical correctness evaluated for the same foreign language sentence by foreign language teachers.

In addition, the server may extract an n-gram, among specific n-grams of the foreign language sentence input by the foreign language learner, which has a probability value lower than or equal to a preset probability value and provide the extracted n-gram as education information. As an example, the server may extract an n-gram having a low probability of appearing in a foreign language learning language model including the first to third evaluation models M1 to M3 among specific n-grams of the foreign language sentence input by the foreign language learner, and provide the extracted n-gram as education information.

The foreign language learner who is provided with the education information related to grammatical correctness may identify grammatical errors and corrections that occur in the foreign language sentences spoken or written by him or herself.

Referring to FIG. 1 again, the server may compare the calculated second evaluation result value with the predetermined result value, and when the second evaluation result value is greater than or equal to the predetermined result value, input the foreign language sentence into a third evaluation model M3 corresponding to a third evaluation item following the second evaluation item to calculate a third evaluation result value (S133). In this process, the server evaluates the expressive fluency of the foreign language sentence by the foreign language learner on the basis of the third evaluation model M3 that is pre-trained.

The server may perform training on the third evaluation model M3 on the basis of training data prepared in advance (S131).

In this case, the training data prepared in advance may be expressive fluency evaluation training data. The expressive fluency evaluation training data is data, with respect to foreign language sentences generated by foreign language learners having various skills and experiences, that is obtained by evaluating whether the foreign language sentences are fluent only in a language fluency aspect and scoring the evaluation by the foreign language teachers.

Accordingly, the expressive fluency evaluation training data includes foreign language sentences generated by a plurality of foreign language learners and an average third evaluation result value obtained by evaluating the expressive fluency of the foreign language sentences in scores by the foreign language teachers.

In general, the foreign language teachers for evaluation may be preferably set to three or four people, and the evaluation score may be set to zero to four points. The evaluation criteria may vary depending on an education object or methodology, and a third evaluation result value of four points is assigned when the expressive fluency is perfect, and a third evaluation result value of zero points is assigned when the expressive fluency is the lowest.

In this case, the average third evaluation result value by the foreign language teachers may be converted to a value between zero and one when the third evaluation model M3 is a regression model, and the average third evaluation result value may be determined as a score between zero and four that is the most similar to the average score when the third evaluation model M3 is a classification model.

The server generates the third evaluation model M3 to be similar to the result of the foreign language sentences of the foreign language students actually evaluated by the foreign language teachers on the basis of the expressive fluency evaluation training data. For example, the server may train the third evaluation model M3 to be similar to the evaluation result by the foreign language teachers to a preset degree of reliability required for learning. In this case, the preset degree of reliability is determined, for example, according to a proportion that matches detailed evaluation item objects of expressive fluency evaluated by foreign language teachers in practice, or according to a predetermined error ratio of result values of expressive fluency evaluated for the same foreign language sentence by foreign language teachers.

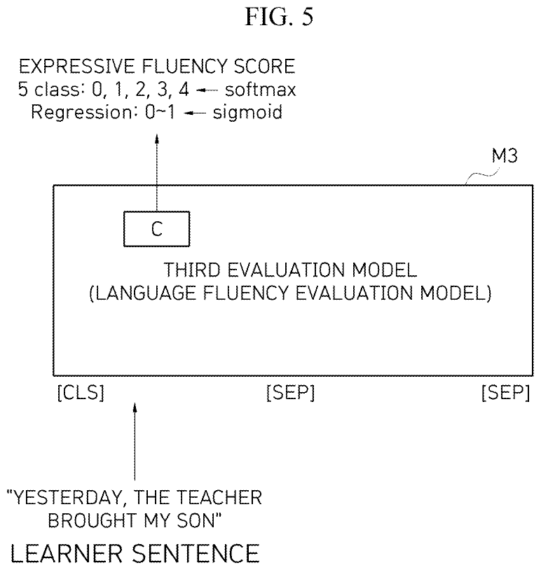

FIG. 5 is a diagram for describing a third evaluation model.

In one embodiment, with respect to the third evaluation model M3 based on a neural network that is pre-trained on the basis of a large-capacity language corpus collected for a predetermined period, the server may set the foreign language sentence in the expressive fluency evaluation training data as input data and set the average third evaluation result value as output data to train the third evaluation model M3.

Here, the third evaluation model M3 may be a neural network-based language model, such as BERT, pre-trained using a latest large-capacity language corpus, similar to the first evaluation model M1.

The server may construct the third evaluation model M3 by setting the foreign language sentence of the foreign language learner in the expressive fluency evaluation training data as an input of the third evaluation model M3 and training the model by fine-tuning learning such that the result is determined as the average third evaluation result value by the foreign language teachers.

When the construction of the third evaluation model M3 is completed as such, the server inputs a foreign language sentence input by a foreign language learner into the third evaluation model M3. In addition, the server calculates a third evaluation result value of evaluating the expressive fluency of the foreign language sentence on the basis of the third evaluation model M3.

In one embodiment, the server may classify the expressive fluency of the foreign language sentence input by the foreign language learner into a score between zero and four points when using a classification model and output an evaluation result value between zero and one when using a regression model. In this case, as the result becomes closer to four points in the classification model and the result becomes closer to one in the regression model, the expressive fluency of the foreign language sentence generated by the foreign language learner is considered to be high.

Referring to FIG. 1 again, the server compares the calculated third evaluation result value with a predetermined result value (S135), and when a result of the comparison is determined that the third evaluation result is less than the predetermined result value, provides the foreign language learner with education information corresponding to the third evaluation item (S137).

For example, when the third evaluation result value by the classification model is less than three points, or when the third evaluation result value by the regression model is less than 0.7, the server may determine the expressive fluency to be inappropriate and thus provide the foreign language learner with education information corresponding to expressive fluency.

In one embodiment, the server may provide, as education information related to the expressive fluency, the third evaluation result value converted into a predetermined score (for example, 100 points) or the degree of fluency converted into a predetermined grade or converted into a picture representation to the foreign language learner.

In addition, the server may provide, as the education information, a correct answer sentence input by another foreign language learner and evaluated as a correct answer, or a correct answer sentence generated by combining pre-prepared correct answer sentences to the foreign language learner. In this case, the server may extract a correct answer sentence having the highest similarity according to a proportion that matches detailed evaluation item objects of expressive fluency evaluated by foreign language teachers in practice.

As another example, the server may provide, as the education information, a correct answer sentence newly generated by combining n-grams having the highest probability of appearing in a foreign language learning language model from among a plurality of correct answer sentences to the foreign language learner.

The foreign language learner who is provided with the education information related to expressive fluency may identify where incomplete fluency occurs in the foreign language sentence spoken or written by him or herself.

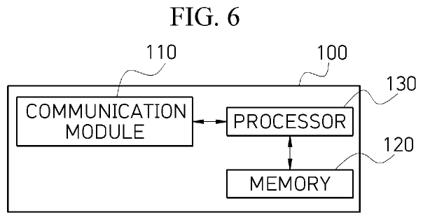

Meanwhile, in the above description, operations S100 to S230 may be further divided into a larger number of operations or combined into a smaller number of operations according to examples of implementation of the present invention. In addition, some of the operations may be omitted or may be executed in the reverse order as needed. Parts omitted in the following description, which have been described above with reference to FIGS. 1 to 5, may be applied to the apparatus 100 for providing foreign language education shown in FIG. 6.

Hereinafter, the apparatus 100 for providing foreign language education based on evaluation of a foreign language sentence of a foreign language learner according to an embodiment of the present invention (hereinafter referred to as an apparatus for providing foreign language education) will be described.

FIG. 6 is a diagram for describing the apparatus 100 for providing foreign language education according to an embodiment of the present invention.

Referring to FIG. 6, the apparatus 100 for providing foreign language education includes a communication module 110, a memory 120, and a processor 130.

The communication module 110 receives at least one foreign language sentence generated from a foreign language learner and provides an evaluation result on the foreign language sentence and education information to the foreign language learner.

The memory 120 stores a program for providing education information to the foreign language learner on the basis of a result of evaluating the foreign language sentence, and the processor 130 executes the program stored in the memory 120.

The processor 130 inputs a foreign language sentence into evaluation models corresponding to a plurality of evaluation items to calculate evaluation result values, and as a result of comparing each calculated evaluation result value with a predetermined result value, provides the foreign language learner with education information related to an evaluation item corresponding to an evaluation result value that is less than the predetermined result value.

In another embodiment, the processor 130 sequentially inputs a foreign language sentence into evaluation models corresponding to evaluation items of a content delivery competency, grammatical correctness, and an expressive fluency to calculate evaluation result values, and as a result of comparing each evaluation result value with a predetermined result value, provides the foreign language learner with education information related to an evaluation item corresponding to an evaluation result value that is less than the predetermined result value.

The method of providing foreign language education based on evaluation of a foreign language sentence of a foreign language learner according to the embodiment of the present invention may be implemented as a program (or an application) to be executed in combination with a server, which is hardware, and stored in a medium.

The program may include codes coded in a computer language C, C++, Pyhthon, Java, other machine language, etc., that can be read by a processor (a central processing unit (CPU) and/or a graphics processing unit(GPU)) of a computer through a device interface of the computer in order for the computer to read the program and execute the methods implemented as the program. The code may include a functional code that is related to a function that defines functions needed to execute the methods and may include an execution procedure related control code needed to cause the processor of the computer to execute the functions according to a predetermined procedure. In addition, the code may further include a memory reference related code as to whether additional information or media needed to cause the processor of the computer to execute the functions should be referred to at a location (an address) of an internal or external memory of the computer. In addition, when the processor of the computer needs to communicate with any other computers or servers, etc. at a remote site, to perform the above-described functions, the code may further include communication related codes such as how to communicate with any other computers or servers at a remote site and what information or media should be transmitted or received during communication.

The storage medium does not refer to a medium that stores data for a short period of time, such as a register, cache, memory, etc., but refers to a medium that stores data semi-permanently and can be read by a device. Specifically, examples of the storage medium include may include a read-only memory (ROM), a random-access memory (RAM), a compact disc (CD)-ROM, a magnetic tape, a floppy disk, an optical data storage device, etc., but are not limited thereto. That is, the program may be stored in various recording media on various servers which the computer can access or on various recording media on the computer of the user. In addition, the medium may be distributed over computer systems connected through a network so that computer-readable codes may be stored in a distributed manner.

The operations of the method or algorithm described in connection with the embodiment of the present invention may be implemented directly in hardware, implemented in a software module executed by hardware, or a combination thereof. Software modules may reside in a RAM, a ROM, an Erasable Programmable ROM (EPROM), an Electrically Erasable Programmable ROM (EEPROM), a flash memory, a hard disk, a removable disk, a CD-ROM, or any other form of computer-readable recording medium known in the art to which the present invention pertains.

As is apparent from the above, a sentence written or spoken by a foreign language learner is evaluated in terms of content, grammar, and expression, and based on a result of the evaluation, the most appropriate foreign language education information is provided to the foreign language learner so that the foreign language learner can understand and learn a part that is wrong or a part that is to be corrected.

In addition, when a foreign language learner conducts a conversation in a specific situation, a sentence spoken in each conversation context situation is determined in term of the content delivery competency, grammatical correctness, and expressive fluency, and the result is provided to the foreign language learner after termination of the conversation or during the conversation so that the foreign language learner can be given feedback about whether the sentence spoken by the foreign language learner is appropriate as a foreign language and thus can acquire foreign language expressions with more accuracy.

The effects of the present invention are not limited to those described above, and other effects not mentioned above will be clearly understood by those skilled in the art from the above detailed description.

It should be understood that the effects of the present disclosure are not limited to the above effects and include all effects that can be deduced from the detailed description of the present disclosure or the configuration of the present disclosure described in the claims.

What is claimed is:

1. A method for providing foreign language education based on evaluation of a foreign language sentence of a foreign language learner, which is performed by a computer, the method comprising:
receiving at least one foreign language sentence generated from a foreign language learner;
inputting the foreign language sentence into a first evaluation model corresponding to a first evaluation item among a plurality of evaluation items to calculate a first evaluation result value;
comparing the calculated first evaluation result value with a predetermined result value; and
when a result of the comparison is that the first evaluation result value is less than the predetermined result value, providing education information corresponding to the first evaluation item to the foreign language learner,
wherein evaluation models corresponding to the plurality of evaluation items are trained on the basis of training data prepared in advance for each of the plurality of evaluation items, and
the training data prepared in advance includes a plurality of foreign language sentences previously generated from the foreign language learner and a first evaluation result value of the previously generated plurality of foreign language sentences by a foreign language teacher.

2. The method of claim 1, wherein the inputting of the foreign language sentence into the first evaluation model corresponding to the first evaluation item among the plurality of evaluation items to calculate the first evaluation result value includes:
inputting a foreign language sentence input by the foreign language learner and a correct answer sentence, which correspond to a preset situation condition, into the first evaluation model; and
calculating the first evaluation result value of evaluating a content delivery competency of the foreign language sentence compared to the correct answer sentence on the basis of the first evaluation model.

3. The method of claim 2, further comprising training the first evaluation model on the basis of the training data prepared in advance,
wherein the training data prepared in advance is content delivery competency evaluation training data, and
the content delivery competency evaluation training data includes foreign language sentences generated by a plurality of foreign language learners with respect to a content and situation defined in a plurality of preset situation conditions that is recognized in native languages of the plurality of foreign language learners, correct answer sentences corresponding to the foreign language sentences, and an average first evaluation result value evaluated by a plurality of foreign language teachers on the basis of the correct answer sentences.

4. The method of claim 3, wherein the training of the first evaluation model on the basis of the training data prepared in advance includes:
with respect to the first evaluation model, which is based on a neural network and which is pre-trained on the basis of a large-capacity language corpus collected for a predetermined period, setting the foreign language sentence and the correct answer sentence as input data and setting the average first evaluation result value as output data; and
performing the training on the first evaluation model.

5. The method of claim 2, wherein the providing of the education information corresponding to the first evaluation item to the foreign language learner includes:
when the first evaluation result value of evaluating the content delivery competency is less than the predetermined result value, extracting the first evaluation result value, the correct answer sentence, and a keyword in the correct answer sentence that is not included in the foreign language sentence input by the foreign language learner; and
providing the extracted first evaluation result value, correct answer sentence, and keyword as the education information.

6. The method of claim 1, further comprising:
when the result of the comparison is that the first evaluation result value is greater than or equal to the predetermined result value, inputting the foreign language sentence into a second evaluation model corresponding to a second evaluation item following the first evaluation item to calculate a second evaluation result value;
comparing the calculated second evaluation result value with a predetermined result value; and
when a result of the comparison is that the second evaluation result value is less than the predetermined result value, providing education information corresponding to the second valuation item to the foreign language learner.

7. The method of claim 6, wherein the inputting of the foreign language sentence into the second evaluation model to calculate the second evaluation result value includes:
inputting the foreign language sentence input by the foreign language learner into the second evaluation model; and
calculating the second evaluation result value of evaluating grammatical correctness for the foreign language sentence on the basis of the second evaluation model.

8. The method of claim 7, further comprising training the second evaluation model on the basis of the training data prepared in advance,
wherein the training data prepared in advance is grammatical correctness evaluation training data, and
the grammatical correctness evaluation training data includes foreign language sentences generated by a plurality of foreign language learners and an average second evaluation result value obtained by evaluating the grammatical correctness of the foreign language sentences in scores by the foreign language teacher.

9. The method of claim 8, wherein the training of the second evaluation model on the basis of the training data prepared in advance includes:
with respect to the second evaluation model, which is based on a neural network and which is pre-trained on the basis of a large-capacity language corpus collected for a predetermined period, setting the foreign language sentence as input data and setting the average second evaluation result value as output data; and
performing the training on the second evaluation model.

10. The method of claim 7, wherein the providing of the education information corresponding to the second evaluation item to the foreign language learner includes, when the second evaluation result value of evaluating the grammatical correctness is less than the predetermined result value, providing the second evaluation result value, a correct answer sentence input by another foreign language learner and evaluated as a correct answer, or a correct answer sentence among pre-prepared correct answer sentences that is determined to have a highest similarity as the education information.

11. The method of claim 7, wherein the providing of the education information corresponding to the second evaluation item to the foreign language learner includes:
when the second evaluation result value of evaluating the grammatical correctness is less than the predetermined result value, extracting the second evaluation result value and an n-gram among specific n-grams of the input foreign language sentence that has a probability value lower than or equal to a preset probability value; and
providing the extracted second evaluation result value and n-gram as the education information.

12. The method of claim 6, further comprising:
when the result of the comparison is that the second evaluation result value is greater than or equal to the predetermined result value, inputting the foreign language sentence into a third evaluation model corresponding to a third evaluation item following the second evaluation item to calculate a third evaluation result value;
comparing the calculated third evaluation result value with a predetermined result value; and
when a result of the comparison is that the third evaluation result value is less than the predetermined result value, providing education information corresponding to the third evaluation item to the foreign language learner.

13. The method of claim 12, wherein the inputting of the foreign language sentence into the third evaluation model to calculate the third evaluation result value includes:
inputting the foreign language sentence input by the foreign language learner into the third evaluation model; and
calculating the third evaluation result value of evaluating an expressive fluency for the foreign language sentence on the basis of the third evaluation model.

14. The method of claim 13, further comprising training the third evaluation model on the basis of the training data prepared in advance,
wherein the training data prepared in advance is expressive fluency evaluation training data, and
the expressive fluency evaluation training data includes foreign language sentences generated by a plurality of foreign language learners and an average third evaluation result value obtained by evaluating the expressive fluency of the foreign language sentences in scores by the foreign language teacher.

15. The method of claim 14, wherein the training of the third evaluation model on the basis of the training data prepared in advance includes:
with respect to the third evaluation model, which is based on a neural network and which is pre-trained based on a large-capacity language corpus collected for a predetermined period, setting the foreign language sentence as input data and setting the average third evaluation result value as output data; and
performing the training on the third evaluation model.

16. The method of claim 13, wherein the providing of the education information corresponding to the third evaluation item to the foreign language learner includes, when the third evaluation result value of evaluating the expressive fluency is less than the predetermined result value, providing the third evaluation result value, a correct answer sentence input by another foreign language learner and evaluated as a correct answer, at least one pre-prepared correct answer sentence, or a correct answer sentence combined on the basis of probability values of specific n-grams included in the correct sentence as the education information.

17. An apparatus for providing foreign language education based on evaluation of a foreign language sentence of a foreign language learner, the apparatus comprising:
a communication module configured to receive at least one foreign language sentence generated from a foreign language learner;
a memory in which a program for providing education information to the foreign language learner on the basis of a result of evaluating the foreign language sentence is stored; and
a processor configured to execute the program stored in the memory,
wherein the processor executes the program to input the foreign language sentence into evaluation models corresponding to a plurality of evaluation items to calculate evaluation result values, and as a result of comparing each of the calculated evaluation result values with a predetermined result value, provide education information corresponding to the evaluation item associated with the evaluation result value which is less than the predetermined result value to the foreign language learner;
wherein the evaluation models corresponding to the plurality of evaluation items are trained on the basis of training data prepared in advance for each of the plurality of evaluation items, and
wherein the training data prepared in advance includes a plurality of foreign language sentences previously generated from the foreign language learner and an evaluation result value of the previously generated plurality of foreign language sentences by a foreign language teacher.

18. An apparatus for providing foreign language education based on evaluation of a foreign language sentence of a foreign language learner, the apparatus comprising:
a communication module configured to receive at least one foreign language sentence generated from a foreign language learner;
a memory in which a program is stored, wherein the program is for evaluating evaluation items of a content delivery competency, grammatical correctness, and an expressive fluency with respect to the foreign language sentence and providing the foreign language learner with education information corresponding to each of the evaluation items; and
a processor configured to execute the program stored in the memory,
wherein the processor executes the program to input the foreign language sentence into evaluation models corresponding to the evaluation items of the content delivery competency, the grammatical correctness, and the expressive fluency to calculate evaluation result values, and as a result of comparing each of the calculated evaluation result values with a predetermined result value, provide education information corresponding to the evaluation item associated with the evaluation result value which is less than the predetermined result value to the foreign language learner,
wherein the evaluation models corresponding to the plurality of evaluation items are trained on the basis of training data prepared in advance for each of the plurality of evaluation items, and
wherein the training data prepared in advance includes a plurality of foreign language sentences previously generated from the foreign language learner and an evaluation result value of the previously generated plurality of foreign language sentences by a foreign language teacher.

19. The apparatus of claim 18, wherein the processor, when the evaluation result value is greater than or equal to the predetermined result value as a result of comparing each of the evaluation result values with the predetermined result value, inputs the foreign language sentence into the evaluation model corresponding to the next evaluation item.

20. The apparatus of claim 18, wherein the processor, when the evaluation result value is less than the predetermined result value as a result of comparing each of the evaluation result values with the predetermined result value, provides at least one of the evaluation result value, a correct answer sentence, and a keyword extracted from the correct answer sentence, n-gram information, and a correct answer sentence generated by combining the evaluation result value, the correct answer sentence, and the keyword extracted from the correct answer sentence, and the n-gram information.
